(19) United States
(12) Patent Application Publication
(10) Pub. No.: US 2015/0358044 A1
(43) Pub. Date: Dec. 10, 2015

(54) Electronic Mobile Device Holder

(71) Applicant: Mark Barstead, Winnipeg (CA)

(72) Inventor: Mark Barstead, Winnipeg (CA)

(21) Appl. No.: 14/731,828

(22) Filed: Jun. 5, 2015

Related U.S. Application Data
(60) Provisional application No. 62/008,102, filed on Jun. 5, 2014.

(51) Int. Cl. H04B 1/3877

(52) U.S. Cl. CPC H04B 1/3877

(57) ABSTRACT

The present invention provides an adjustable mobile electronic device holder that enables a user to operate a mobile electronic device such as a cell phone, tablet, or electronic reader in a hands free manner. The adjustable mobile electronic device holder includes a flexible arm interconnected with a plurality of flexible legs adapted to wrap around and grip a fixed object at a first end and a clamp mechanism adapted to secure a mobile electronic device at a second end. The clamp mechanism for securing the mobile electronic device includes a plurality of adjustable, flexible fingers that can grip the mobile electronic device placed therein. The flexible legs include independently adjustable ball and socket connectors in a linear arrangement. The flexible legs are used to mount the device onto the user's body or a fixed object whereby the mobile electronic device can be moved into a desired position for viewing.

### CROSS REFERENCE TO RELATED APPLICATION

This application claims the benefit of U.S. Provisional Application No. 62/008,102 filed on Jun. 5, 2014. The above identified patent application is herein incorporated by reference in its entirety to provide continuity of disclosure.

### BACKGROUND OF THE INVENTION

1. Field of the Invention

The present invention relates to an electronic mobile device holder apparatus adapted for hands-free use. More specifically, the present invention provides a flexible arm with a plurality of flexible legs adapted to wrap around and grip a fixed object at a first end and a clamp mechanism disposed at a second end of the flexible arm. The flexible arm attaches to both the plurality of flexible legs and clamp mechanism by a joint, wherein the joint is preferably a ball and socket joint. The clamp mechanism is adapted to secure a mobile electronic device in a position suitable for hands free viewing, while the flexible legs are adapted to be secured to a support structure, such as the user's body.

Over recent years there has been an upsurge in electronic mobile device usage worldwide. Electronic mobile devices, including cell phones, tablets, electronic readers, and the like are capable of wirelessly displaying text, audio, and video. When using an electronic device, a user is normally required to hold the device in his or her hands which can pose problems if the user is engaging in another activity. Alternatively, the user may place the electronic mobile device on a table, countertop, or another location which may not be suitable for displaying and holding the electronic mobile device at an appropriate angle for viewing.

Many individuals are forced to look down at their electronic devices when reading, playing games, and the like thereon. This can cause neck and back pain and can become every uncomfortable after prolonged periods of use. Further, individuals are required to utilize both hands in order to hold the device and use it at the same time. The device can slip from one's hand and fall on the ground causing damage to the screen and other areas. Accordingly, there exists a need for an electronic device holder that allows a user to remain hands free while having easy access to their device when needed.

2. Description of the Prior Art

Devices have been disclosed in the prior art that relate to adjustable electronic device holders. These include devices that have been patented and published in patent application publications. These devices generally relate to adjustable electronic device holders adapted to secure electronic device therein and mount the electronic device holders onto or atop a substantially fixed surface.

One such device, U.S. Published Patent Application Number 2008/0056808 to Bevirt discloses a flexible support apparatus having removable clips adapted to secure the electronics thereon. The apparatus consists of a series of ball and socket connectors interconnected into a flexible chain having the removable clips disposed at one or both ends of the chain. The apparatus is adapted to wrap around and grip an element, such as a pole, while supporting a device such as a camera, flash unit, cell phone, or other item. This arrangement is inconvenient because single arm and socket connectors limit the versatility and usage of the device.

U.S. Pat. No. 7,861,985 to Galvin discloses a hands-free electronic device holder for holding handheld electronic devices. The hands-free device holder has a flexible adjustable gooseneck and a pocket member that secures to the backside of the handheld electronic device. The pocket member is impractical based on the orientation limitations that is required to secure the mobile electronic device therein.

U.S. Published Patent Application Number 2003/0180088 to Camevali discloses a universally adjustable ball and socket mounting device. The ball and socket mounting device comprises a base adapted for permanent mounting and a series of one or more rotatably interconnecting columnar ball and socket elements. While Camevali discloses a universally adjustable ball and socket mounting device, Camevali fails to disclose a universally adjustable ball and socket mounting device having a flexible arm with a clamp mechanism disposed at a first end and a joint disposed at a second end.

U.S. Pat. No. 5,903,645 to Tsay discloses a clamping device for mobile phones. The clamping device comprises a fork-shaped link pivotally connected to a clamp seat at either end. While Tsay discloses a clamping device for mobile phones, Tsay fails to disclose a flexible arm with a plurality of flexible legs adapted to wrap around and grip a fixed object at a first end and a clamp mechanism disposed at a second end of the flexible arm.

U.S. Pat. No. 6,626,210 to Luettgen and Cammack discloses a bead and interconnecting bead structure for use in a flexible arm assembly. The flexible arm assembly comprises a bead and interlocking bead structure adjustable in three dimensions and also adapted to support a showerhead. Thus, Luettgen and Cammack do not disclose a flexible arm with a plurality of flexible legs adapted to wrap around and grip a fixed object at a first end and a clamp mechanism disposed at a second end of the flexible arm.

U.S. Pat. No. 7,290,740 to Joy and Congdon discloses a universal mounting assembly for quick mounting an object to a stand device. The device comprises a body having a support surface, a front face and an opposed mounting surface configured to mount to the support stand. The universal mounting assembly lacks a flexible arm that can selectively position the attached electronic mobile device.

Finally, U.S. Published Patent Application Number 2011/0042536 to Phillips and Norman discloses a device for securing an instrument that includes at least one flexible, bendable leg with a grippable surface. The selectively positional device comprises at least one mount adapted to receive and support an electronic device. The mount may be configured as a plate, a clamp, a snap-fit, or other interface configured for attaching an object to the device. Thus, Phillips and Norman fails to disclose a pivotable connected clamp mechanism further comprising a plurality of fingers adapted to securely grasp a mobile electronic device.

These prior art devices have several known drawbacks. The devices in the prior art generally relate to adjustable electronic device holders adapted to secure an electronic device therein. However, the devices in the prior art are not adapted to wrap around and grip a fixed object at a first end and a clamp mechanism adapted to secure a mobile electronic device at a second end. Further, the devices fail to provide a clamp mechanism for securing the mobile electronic device that includes a plurality of adjustable flexible fingers that may wrap around and grip the mobile electronic device placed therein. Thus, the devices in the prior art are not well suited for enabling a user to operate a mobile electronic device such as a cell phone, tablet, or electronic reader, hands free.

In light of the devices disclosed in the prior art, it is submitted that the present invention substantially diverges in design elements from the prior art and consequently it is clear that there is a need in the art for an improvement to existing mobile electronic device holder apparatuses. In this regard the instant invention substantially fulfills these needs.

### SUMMARY OF THE INVENTION

In view of the foregoing disadvantages inherent in the known types of mobile electronic device holder apparatus now present in the prior art, the present invention provides a new mobile electronic device holder apparatus wherein the same can be utilized for providing convenience for the user when using mobile electronic devices.

It is therefore an object of the present invention to provide a new and improved mobile electronic device holder apparatus that has all of the advantages of the prior art and none of the disadvantages.

It is another object of the present invention to provide a mobile electronic device holder apparatus comprising a flexible arm having a clamp mechanism on a first end and a plurality of flexible legs on a second end thereof, wherein the plurality of flexible legs is adapted to secure the device to a fixed object.

Another object of the present invention is to provide a mobile electronic device holder apparatus that allows the user operate the mobile electronic device hands free.

Another object of the present invention is to provide a mobile electronic device holder apparatus having a clamp mechanism comprising a plurality of fingers that are independently adjustable and can telescopically extend, retract, and lock into position by means of a twist lock mechanism.

Yet another object of the present invention is to provide a mobile electronic device holder apparatus that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the mobile electronic device holder apparatus.

FIG. 2 shows a front view of the mobile electronic device holder apparatus grasping a mobile electronic device.

FIG. 3 shows a close-up view of the plurality of flexible legs affixed to the second end.

FIG. 4 shows a close-up view of the clamp mechanism of the mobile electronic device holder apparatus.

FIG. 5 shows a cross-sectional view of the clamp mechanism of the mobile electronic device holder apparatus in an alternative embodiment.

FIG. 6 shows a profile view of the mobile electronic device holder apparatus in an alternative embodiment with the plurality of flexible legs secured to a fixed pole.

### DETAILED DESCRIPTION OF THE INVENTION

Reference is made herein to the attached drawings. Like reference numerals are used throughout the drawings to depict like or similar elements of the mobile electronic device holder apparatus. For the purposes of presenting a brief and clear description of the present invention, the preferred embodiment will be discussed as used for supporting a mobile electronic device without the use of the user's hands. The figures are intended for representative purposes only and should not be considered to be limiting in any respect.

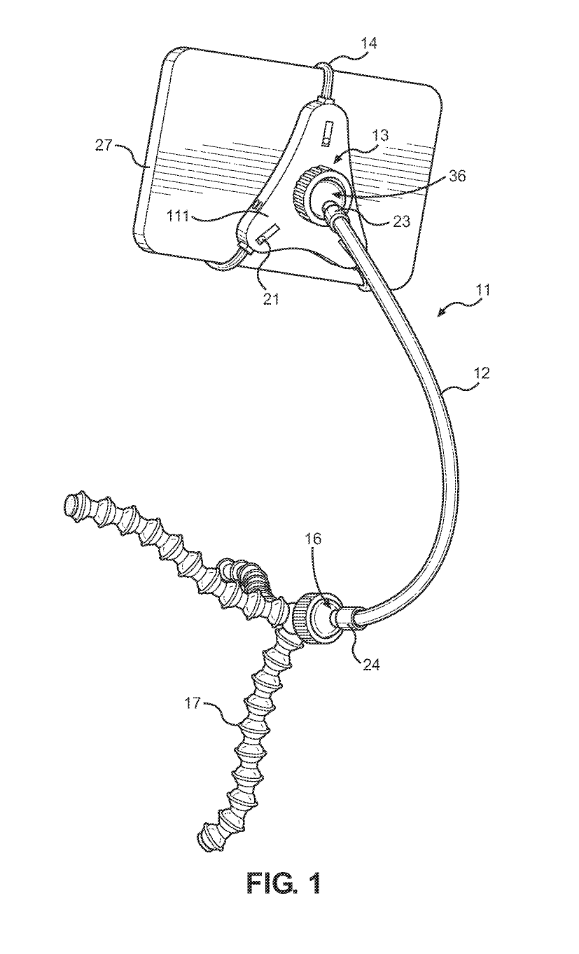

Referring now to FIG. 1, there is a perspective view of an embodiment of the mobile electronic device holder apparatus 11. The mobile electronic device holder apparatus 11 comprises a flexible arm 12 having a first end 23 and a second end 24. The flexible arm 12 preferably comprises gooseneck tubing. A clamp mechanism 13 is disposed on the first end 23 of the flexible arm 12. The clamp mechanism 13 is pivotally connected to the first end 23 of the flexible arm 12. The clamp mechanism 13 includes a housing 111 and plurality of fingers 14 that extend therefrom. The plurality of fingers 14 are adapted to securely grasp a variety of mobile electronic devices 27 including but not limited to cell phones, tablet computers, and handheld electronic readers. A plurality of flexible legs 17 is disposed on the second end 24 of the flexible arm 12. The plurality of flexible legs 17 is adapted to wrap around and grip a fixed object.

In the illustrated embodiment, a twist lock mechanism 21 in the housing 111 of the clamp mechanism 13 rotates to lock or release the finger member 14 for linear adjustment. The clamp mechanism 13 may be configured in an expanded or retracted configuration. In a retracted configuration, the proximal end of at least one said finger of the plurality of fingers 14 is substantially and selectively positioned within the housing 111 of the clamp mechanism 13. In this retracted configuration, the linear length of the exposed finger 14 is reduced when compared to when the finger 14 is in an expanded configuration. In an expanded configuration, the linear length of the plurality of fingers 14 is substantially longer than in the retracted configuration. The increase in linear length provides for the plurality of fingers 14 to grasp larger mobile electronic devices 27 therebetween.

In operation, the clamp mechanism 13 is initially configured in an expanded configuration providing sufficient clearance between the plurality of fingers 14 for the insertion of a mobile electronic device 27 therebetween. The backside of the mobile electronic device 27 is positioned substantially flush with the clamping mechanism 13 with the screen facing outwardly. Then, the fingers 14 are telescopically retracted within the clamping mechanism 13 until the fingers 14 grip the mobile electronic device 27 securely. Next, a twist lock mechanism 21 in the clamp mechanism 13 is rotated to lock the position of the fingers 14. The clamp mechanism 13 is pivotably adjusted by rotating a ball and socket joint 36 disposed towards the first end 23 of the flexible arm 12. When released, the clamp mechanism 13 is reposition in relation to the previous position, and then secured by closing the ball and socket joint 36. The mobile electronic device holder apparatus 11 may be positioned on or around a fixed object and the clamping mechanism 13 allows the attached mobile electronic device 27 to be independently and selectively rotated and position. This provides a multitude of viewing angles suitable for displaying the attached mobile electronic device 27. This provides a multitude of viewing angles suitable for displaying the attached mobile electronic device 27.

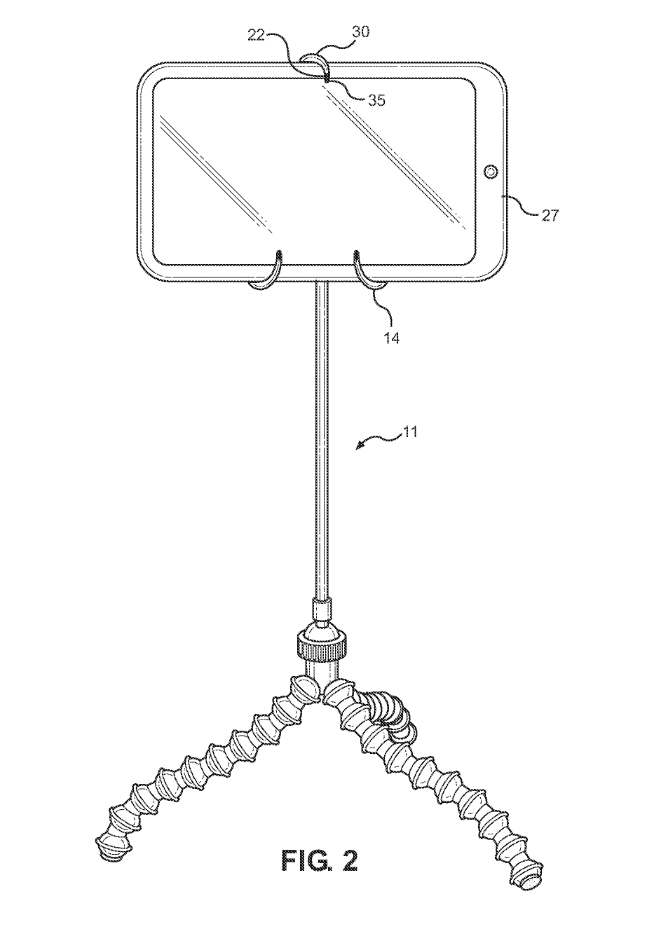

Referring now to FIG. 2, there is shown a frontal view of the mobile electronic device holder apparatus 11. In the illustrated embodiment, the plurality of flexible legs 17 is disposed on the second end 24 of the flexible arm 12. The plurality of flexible legs 17 is connected to a joint 16 that is substantially similar to the ball and socket joint 36 disposed at the opposite end of the flexible arm 12. The plurality of flexible legs 17 are arranged in a tripod configuration and may be adapted to wrap around and grip a fixed object. The plurality of flexible legs 17 may be configured in a variety of ways, including but not limited to the shown tripod configuration where each leg 17 is substantially equiangular, relative to the other legs 17. The tripod configuration provides increased support means when wrapped around a fixed object, thus enabling the present invention to be more utilized in a wider variety of fixed objects such as poles, arms, legs, tabletops, and the like.

In the illustrated embodiment, the plurality of fingers 14 are grasping a mobile electronic device 27. The plurality of fingers 14 are tubular members and the diameter of the plurality of fingers 14 is preferably narrow enough to securely grasp a mobile electronic device 27. At least one said fingers of the plurality of fingers 14 have a high friction tip 22 disposed at the terminal end 35 of said finger 14. The high friction tip 22 provides frictional resistance that secures the grasped mobile electronic devices 27 therein. The high friction tips 22 may be constructed from rubber or other similar material.

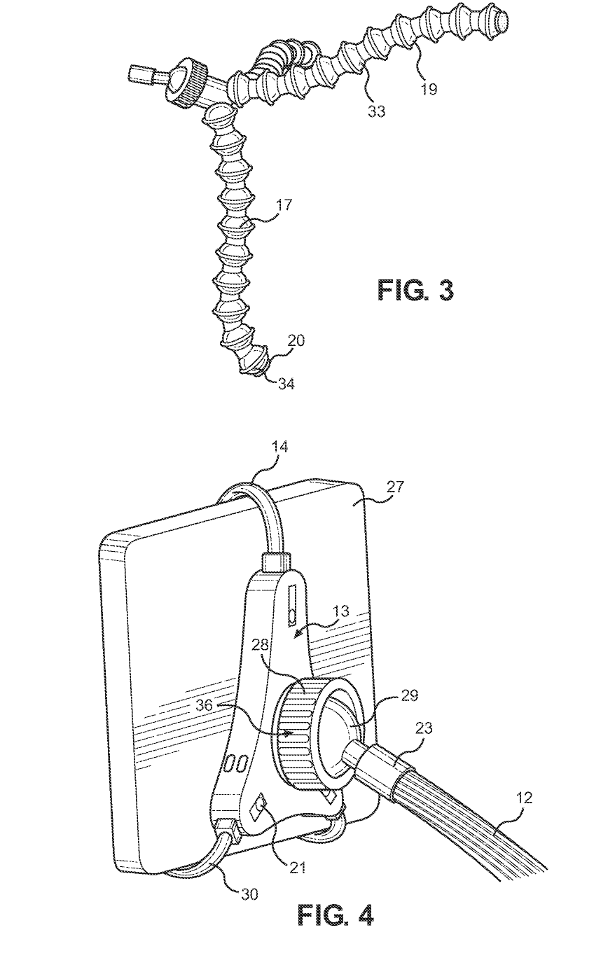

Referring now to FIG. 3, there is shown a close-up view of the plurality of flexible legs 17 affixed to the second end. The plurality of flexible legs 17 include a plurality of ball-and-socket connectors 19 in linear arrangement. The plurality of ball-and-socket connectors 19 are independently-adjustable and in this arrangement the plurality of ball-and-socket connectors 19 provide significant flexibility with regard to its mounting and positioning function. The plurality of ball-and-socket connectors 19 may be constructed of a variety of materials including but, not limited to, plastics. Rubberized grips 20 are disposed at the terminal end 34 of at least one leg of said plurality of flexible legs 17. These rubberized grips 20 provide a high friction surface that resists unwanted movement of the mobile electronic device holder apparatus 11 when positioned atop or wrapped around an object. The rubberized grips 20 is preferably constructed from rubber or other similar material that provides high frictional resistance. This ensures that the mobile electronic device holder apparatus 11 remains in the selectively desired position for optimal viewing.

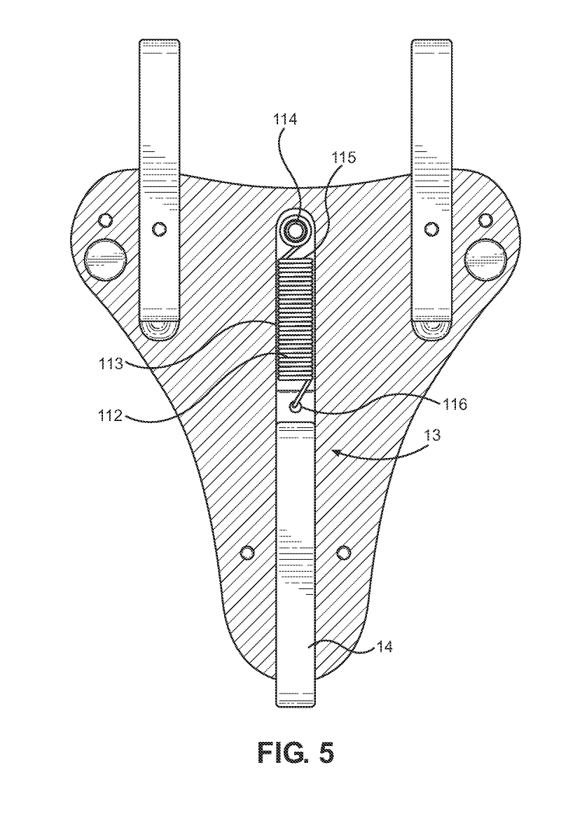

Referring now to FIG. 4, there is close-up view of the clamp mechanism 13 of the mobile electronic device holder apparatus 11. In the illustrated embodiment, the clamp mechanism 13 is pivotally connected to first end 23 of the flexible arm 12 by a ball and socket joint 36. The ball and socket joint 36 provides for pivotal adjustment of the clamp mechanism 13 and the removable mobile electronic device 27 disposed thereon.

In the illustrated embodiment, the ball and socket joint 36 further comprises a ball 29 that is disposed on at the first end 23 of the flexible arm 12. A socket 28 is disposed on the clamp mechanism 13. The socket 28 has a female screw thread and is engaged with the clamp mechanism 13 which has a complementary male screw thread. The ball 29 is positioned within the socket 28. Upon rotation of the socket 28, the first end 23 of the flexible arm 12 can be secured to or released from the clamp mechanism 13. When released, the clamp mechanism 13 can be reposition in relation to the previous position, and then secured by closing the socket 28. This provides adjustability of the clamp mechanism 13 independent of the plurality of flexible leg 17.

Referring now to FIG. 5, there is cross-sectional view of the clamp mechanism 13 in an alternative embodiment. The plurality of fingers 14 extend radially from the housing 111 of the clamp mechanism 13 and grasp a mobile electronic device 27 therein. A spring biased means is disposed within the housing 111 of the clamp mechanism. In this embodiment, the spring biased means comprises a spring member 112 disposed within a hollow channel 113 that is attached to a fixed member 114 at a first end 115 and the proximal end of a said fingers 14 at a second end 116. In this way, at least one of the plurality of fingers 14 are spring biased toward the clamp mechanism 13 and are telescopically configured whereby the proximal end of a finger member 14 can slide into the housing 111 of the clamp mechanism 13. When the plurality of fingers 14 grip a mobile electronic device 27, the plurality of fingers 14 exert a force directed radially inwards from the center of the clamp mechanism 13. This compression force provided by the plurality of fingers 14 contribute additional support for gripping the mobile electronic device placed therein. The plurality of fingers 14 are shaped in any of a variety of geometries including, but not limited to hooks. Further, in some embodiments, the plurality of fingers 14 are positioned on opposing sides of the mobile electronic device 27.

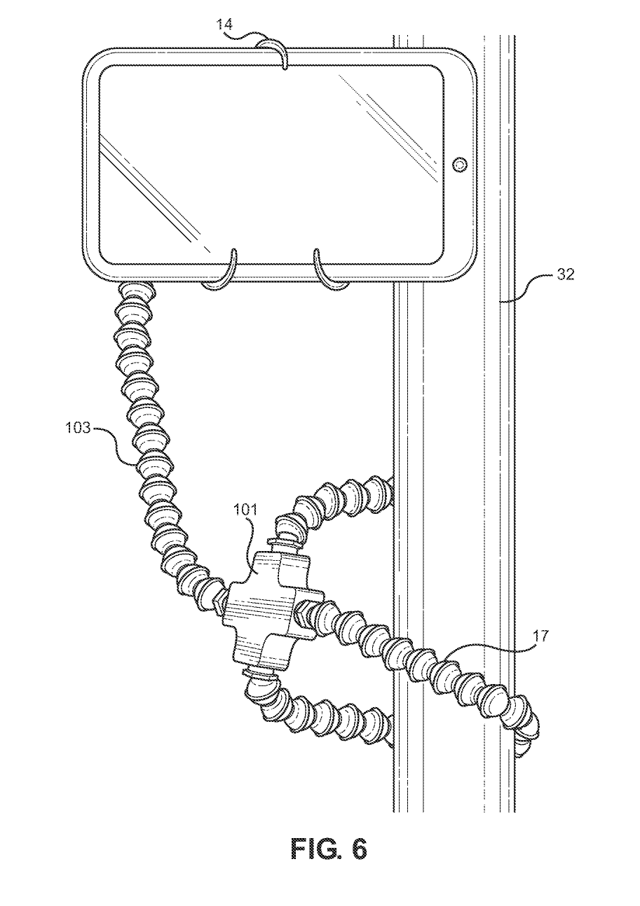

Referring now to FIG. 6, there is a perspective view of the mobile electronic device holder apparatus in an alternative embodiment with the plurality of flexible legs 17 secured to a fixed pole 32. In the illustrated embodiment, the plurality of flexible legs 17 are attached to a joint 16, wherein the joint 16 comprises a cross-shaped connector joint 101. The connector joint 101 includes a plurality of apertures adapted to receive the plurality of flexible legs 17 therein. The connector joint 101 and plurality of flexible legs 17 may be selectively and threadably attached to the connector joint 101. The connector joint 101 is arranged in a quadropodal configuration whereby the threaded apertures are disposed at the protruding sections of the cross-shaped connector joint 101. Each protruding section of the cross-shaped connector joint 101, and threaded apertures, are oriented on the same plane and are positioned at approximately 90 degree angles from the adjacent protruding section. The top and bottom surfaces of the cross-shaped connector joint 101 are substantially flat surfaces that permits the connector to sit atop a table or other surface.

According to the alternative embodiment of the invention, the clamping mechanism 13 is attached to the connector joint 101 by a flexible arm 12 as described herein consists of a plurality of ball-and-socket connectors 103. This flexible arm 12 is substantially similar to the plurality of ball-and-socket connectors 19 disposed on the plurality flexible legs 17. In the shown embodiment, three flexible legs 17 are attached to the connector joint 101 at the proximal end and extend outward until they are wrapped around a fixed object 32, such as a pole. The plurality of flexible legs 17 are capable of being twisted and secured to objects of various size and shape. The flexibility and bendability of the flexible legs 17 increase the adjustability and maneuverability of the device. In addition, the legs 17 preferably provide a grippable surface so that the device can be selectively secured to objects having different shapes and sizes.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mobile electronic device holder apparatus, comprising:
a flexible arm having a first end and a second end;
a clamp mechanism affixed to said first end;
wherein said clamp mechanism comprises a housing having a plurality of fingers adapted to removably secure a mobile electronic device;
a joint affixed to said second end;
a plurality of flexible legs affixed to said joint adapted to be secured to a fixed object.

2) The mobile electronic device holder apparatus of claim 1, wherein said flexible arm comprise a plurality of independently-adjustable ball-and-socket connectors.

3) The mobile electronic device holder apparatus of claim 1, wherein the joint comprises a swivel ball joint.

4) The mobile electronic device holder apparatus of claim 1, wherein the joint comprises a connector joint.

5) The mobile electronic device holder apparatus of claim 1, wherein said plurality of flexible legs comprise a plurality of independently-adjustable ball-and-socket connectors.

6) The mobile electronic device holder apparatus of claim 1, wherein said plurality of flexible legs comprise rubberized grips disposed at a terminal end of said flexible legs.

7) The mobile electronic device holder apparatus of claim 1, wherein said plurality of fingers extend radially from the housing of the clamp mechanism so as to be configured to hold a mobile electronic device.

8) The mobile electronic device holder apparatus of claim 1, wherein said plurality of fingers are telescopic.

9) The mobile electronic device holder apparatus of claim 8, wherein said plurality of fingers further comprise a fastener to lock the plurality of fingers in a fixed position.

10) The mobile electronic device holder apparatus of claim 9, wherein said fastener comprises a twist lock mechanism.

11) The mobile electronic device holder apparatus of claim 9, wherein said fastener comprises a spring biased mechanism.

12) The mobile electronic device holder apparatus of claim 1, wherein said plurality of fingers are independently adjustable.

13) The mobile electronic device holder apparatus of claim 1, wherein said plurality of fingers further comprise high friction tips.

14) The mobile electronic device holder apparatus of claim 1, wherein said clamp mechanism is pivotally connected to said first end of said flexible arm.
